(19) United States
(12) Patent Application Publication
(10) Pub. No.: US 2013/0124130 A1
(43) Pub. Date: May 16, 2013

(54) APPARATUS AND RELATED METHOD FOR MEASURING AND CALIBRATING A UTILITY METER

(71) Applicant: Measurement Controls, Inc., Charlotte, NC (US)

(72) Inventor: Paresh R. Patel, Charlotte, NC (US)

(73) Assignee: Measurement Controls, Inc., Charlotte, NC (US)

(21) Appl. No.: 13/672,259

(22) Filed: Nov. 8, 2012

Related U.S. Application Data
(60) Provisional application No. 61/559,299, filed on Nov. 14, 2011.

(51) Int. Cl. G06F 19/00; G06F 17/16; G01C 1/00

(52) U.S. Cl. 702/94; 702/151

(57) ABSTRACT

An apparatus for reading a utility meter of the type having a dial gauge and a dial pin is disclosed. The apparatus includes a dial gauge interacting device configured for interacting with the utility meter. A control module is in communication with the dial gauge interacting device. The control module is configured to determine a position of the dial based on the interaction of the dial gauge interacting device with the utility meter. The dial gauge interacting device may be a smart phone. A related method is also disclosed.

### CROSS-REFERENCE TO RELATED APPLICATIONS

This application claims priority to U.S. Provisional Patent Application No. 61/559,299 filed on Nov. 14, 2012, the entire contents of which are hereby incorporated by reference.

### TECHNICAL FIELD

This disclosure is related to an apparatus for measuring and calibrating a utility meter, and more particularly, towards an apparatus and related method for measuring and calibrating a utility meter by interacting with one or more dial gauges of the meter to determine a measured value thereof.

### BACKGROUND

Energy consumption is measured in residential and commercial uses with a utility meter. Many conventional utility meters utilize one or more dial gauges that are read and calibrated using the human eye. This occurs at the time the utility meters are installed and placed outside residential or commercial structures and after they begin to incur consumption data. Typically, the utility meter is read at a periodic interval such as, for example, once monthly.

One disadvantage of current methods of reading utility meters is that the data collection involves a high margin of error. The human eye cannot see the fine differentiations in measurements often present in utility meters. For this reason, many utility meters are sent into the market improperly calibrated. This can lead to inaccurate service charges for consumers based on improper energy consumption measurements and may also result in poor customer satisfaction. Furthermore, meters can be placed into use with an incorrect starting value or read incorrectly after installation. For example, if a meter is incorrectly read, the consumer could be over or under charged for a given reading period.

Accordingly, there exists a need for an apparatus and method of properly calibrating utility meters. Additionally, a need exists for an apparatus and method for recording consumption by comparing the start and end readings of a utility meter.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Disclosed herein is an apparatus for measuring a utility meter of the type having one or more dial gauges. In one or more embodiments, the apparatus may display a position or numerical value of the one or more dial gauges on a display screen. The apparatus includes an inlet and outlet support configured for engaging respective inlet and outlet ports of the utility meter. A dial gauge interacting device is configured to interact with the one or more dial gauges to determine at least one position of a dial of the at least one dial gauge. A control module is configured for determining an associated value of the at least one position of a dial based on the interaction of the dial gauges with the dial gauge interacting device.

According to one or more embodiments, the control module is configured for determining a value based on a plurality of dial gauges.

According to one or more embodiments, the control module is configured for determining whether the dial gauge interacting device is interacting with a predetermined number of dial gauges.

According to one or more embodiments, the control module is configured for testing the utility meter by imparting a flow of fluid of a predetermined volume therethrough and determining a value based on a plurality of the dial gauges before and after the step of imparting a flow of fluid of a predetermined volume.

According to one or more embodiments, the control module is configured for displaying on a display screen a representative image of the dial.

According to one or more embodiments, the control module is configured for determining an associated value of the at least one position of a dial of the at least one dial gauge by assigning a representative vector of each dial determining an angle of the representative vector, comparing the angle of the representative vector to a predetermined angle range corresponding a predetermined range, and determining the value associated with the predetermined range.

According to one or more embodiments, a method for measuring and calibrating a utility meter of the type having one or more dial gauges is provided. The method includes interacting with the one or more dial gauges with at least one dial gauge interacting device for determining at least one position of a dial of the at least one dial gauge, and determining an associated value of the at least one position of a dial of the at least one dial gauge.

According to one or more embodiments, the method includes determining a value based on a plurality of dial gauges.

According to one or more embodiments, the method includes determining whether the dial gauge interacting device is interacting with a predetermined number of dial gauges.

According to one or more embodiments, the method includes testing the utility meter by imparting a flow of fluid of a predetermined volume therethrough and determining a value based on a plurality of the dial gauges before and after the step of imparting a flow of fluid of a predetermined volume and comparing the difference in the values to the predetermined volume.

According to one or more embodiments, the method includes displaying on a display screen a representative image of the dial.

According to one or more embodiments, determining an associated value of the at least one position of a dial of the at least one dial gauge includes assigning a representative vector of each dial, determining an angle of the representative vector, comparing the angle of the representative vector to a predetermined angle range corresponding a predetermined value, and determining the predetermined value.

According to one or more embodiments, an apparatus for reading a utility meter of the type having a dial gauge with a dial pin is provided. The apparatus includes a dial gauge interacting device configured for interacting with the utility meter and a control module in communication with the dial gauge interacting device. The control module is configured to determine a position of the dial based on the interaction of the dial gauge interacting device with the utility meter.

According to one or more embodiments, the control module is configured to assign a vector indicative of the position of the dial pin of the dial gauge and determine an angle of the dial pin based on the vector.

According to one or more embodiments, the control module is configured to assign a range of angles indicative of a position of the dial pin and compare the angle of the vector to the range of angles to determine a position of the dial pin.

According to one or more embodiments, the dial gauge includes a plurality of dials and the dial gauge interacting device is configured to interact with each of the dials.

According to one or more embodiments, the control module is configured to determine a usage reading of the utility meter based on the interaction with each of the plurality of dials.

According to one or more embodiments, the dial gauge interacting device is configured to determine if a predetermined number of dial gauges are being interacted with.

According to one or more embodiments, the apparatus includes one of an input flow or an output flow monitoring device. The apparatus may be further configured to impart a fluid flow through one of the input or output flow monitoring devices and compare flow rates to the determined values of the utility meter.

According to one or more embodiments, the apparatus may include a display configured for displaying an image read by the interacting device.

According to one or more embodiments, the control module is configured to display a representative image of the vector on the display.

According to one or more embodiments, the control module is configured to display the usage reading on the display.

According to one or more embodiments, the dial gauge interacting device and the control module are communicatively coupled with a smart phone.

According to one or more embodiments, a method for reading a utility meter of the type having one or more dial gauges having a dial pin indicative of a reading of the dial gauge is provided. The method includes interacting with a utility meter with at least one dial gauge interacting device and determining a position of the dial pin based on the interaction of the dial gauge interacting device with the utility meter.

According to one or more embodiments, the method may include assigning a vector indicative of the position of the dial pin of the dial gauge and determining an angle of the dial pin based on the vector.

According to one or more embodiments, the method may include assigning a range of angles indicative of a position of the dial pin and comparing the angle of the vector to the range of angles to determine a position of the dial pin.

According to one or more embodiments, the method may include, using the dial gauge interacting device, interacting with each of the dials in a utility meter having a plurality of dials.

According to one or more embodiments, the method may include determining a usage reading of the utility meter based on the interaction with each of the plurality of dials.

According to one or more embodiments, the method may include determining if a predetermined number of dial gauges are being interacted with.

According to one or more embodiments, the method may include providing one of an input flow or an output flow monitoring device, and imparting a fluid flow through one of the input or output flow monitoring devices and comparing flow rates to the determined values of the utility meter.

According to one or more embodiments, the method may include displaying a representative image of the vector on the display.

According to one or more embodiments, the method may include displaying the usage reading on the display.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIG. 1 illustrates a front view of a an apparatus for measuring and calibrating a utility meter according to one or more embodiments disclosed herein;

FIG. 2 illustrates a front view of a plurality of dial gauges of a utility meter according to one or more embodiments disclosed herein;

FIG. 3 illustrates a front view of a screen shot of an output on a display screen having representative angle vectors displayed thereon associated with a value of the dial gauges of a utility meter according to one or more embodiments disclosed herein;

FIG. 4 is a flow chart illustrating one or more steps for measuring and calibrating a utility meter according to one or more embodiments disclosed herein;

FIG. 5 is a flow chart illustrating one or more steps for measuring and calibrating a utility meter according to one or more embodiments disclosed herein; and

FIG. 6 illustrates a smart phone embodying a dial gauge interacting device according to one or more embodiments disclosed herein.

### DETAILED DESCRIPTION

The presently disclosed invention is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies.

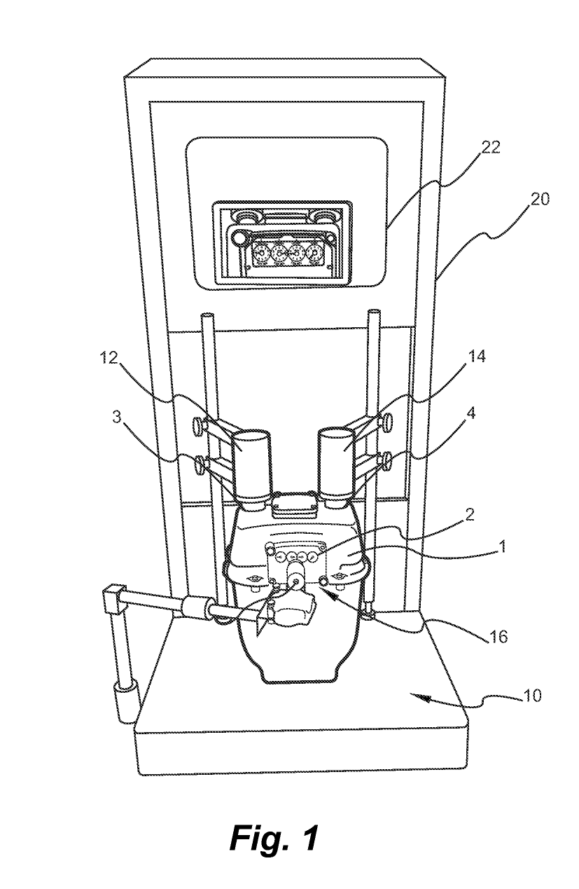

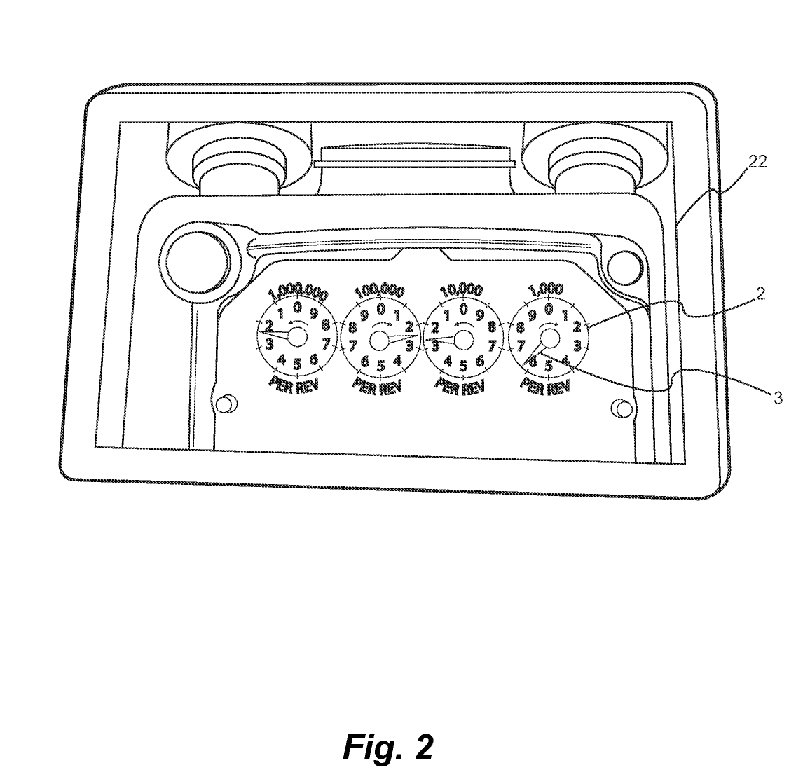

FIGS. 1 through 3 illustrate an apparatus according to one or more embodiments disclosed herein for measuring and calibrating a utility meter 1. The apparatus is generally designated 10 throughout the drawings. The utility meter 1 may be of the type having one or more dial gauges 2. The utility meter 1 may be for measuring consumption of, for example, gas used for commercial and residential HVAC and water heating. The plurality of dial gauges 2 may be provided for determining a flow rate of, for example, gas used by a commercial or residential customer during a given time period. Each dial gauge may signify a certain tens place of gas used. For example, the farthest right dial may be used to illustrate the number of thousands of cubic feet used. Any appropriate volume measurement may be used, including gallons, cubic feet, cubic meters, etc. If the dial gauge pin is between the numbers 6 and 7 as illustrated in FIG. 2, then this may be read to mean that 6,000 gallons of gas have been used. The dial to the left of this dial is indicative of the ten-thousands place, the next dial being indicative of the 100,000 place, and the final dial being indicative of the 1,000,000 place. If a dial pin is positioned between respective numbers, then the lower number is read as the total consumption. This step of reading is done by a human.

Significant error can be introduced when a dial pin is positioned very close to a number on the dial. For example, if the dial pin is pointed substantially directly at the number 6, it may be difficult for the human reading the dial to determine if the pin is between the number 6 and 7, and therefore should be read as a 6, or between the number 5 and 6, and therefore should be read as a 5. If the human reader misreads this number, it could result in the customer being over or under charged.

The one or more apparatuses 10 described herein are particularly advantageous for addressing the reading errors described herein. The apparatus 10 may include an inlet support 12 and an outlet support 14 configured for engaging a respective inlet port 3 and outlet port 4 of the utility meter 1. A dial gauge interacting device 16 is configured to interact with the one or more dial gauges 2 to determine one or more characteristics of the dial gauges 2. For example, the dial gauge interacting device 16 may be configured to determine at least one position of a dial 3 of the at least one dial gauge 2.

The dial gauge interacting device 16 may use, for example, a point source, a line source, or a wave source to provide, for instance, light, sound, ultrasound, radiation, physical contact, and/or other medium for interacting with the one or more dial gauges 2. Such a device 16 may be appropriately configured to use the light, sound, ultrasound, radiation, physical contact and/or other medium to interact with the one or more dial gauges 2. The device 16 may include, for example, at least one corresponding and appropriate emitter/detector pair, or appropriate sensors, for interacting with the one or more dial gauges 1. For instance, the device 16 may be configured to use structured light, laser range finders, or x-rays, or any other suitable measuring technology. For example, an optical methodology or a photographic methodology such as, for instance, stereo-vision techniques, may be used for performing 3D profiling. Various imaging devices such as scanners or cameras may also be suitable in this regard where the interaction may be carried out by associated software or image processing procedure executed on a computer device associated therewith

A control module 20 is configured for determining an associated value 26 of the at least one position of a dial pin 3 based on the interaction of the dial gauges 2 with the dial gauge interacting device 16. In this manner, the control module 20 is configured for determining a value based on the interaction by the dial gauge interacting device 16 with the plurality of dial gauges 2. In one or more embodiments, the control module 20 is configured for determining whether the dial gauge interacting device 16 is interacting with a predetermined number of dial gauges 2. The control module 20 can verify that it is reading all of a predetermined number of dial gauges 2 before interacting therewith. Accordingly, the control module 20 can verify that all of the gauges 2 are being read and that the interacting device 16 is not interacting with less than all of the dial gauges 2. In this manner, the order of the gauges 2 cannot be out of place. If the interacting device 16 expects four dial gauges and only reads three dial gauges, then the control module 20 can instruct the interacting device 16 to interact further with the dial gauge assembly.

In one or more embodiments, the control module 20 communicates with the dial gauge interacting device 16 in order to determine that a predetermined number of dial gauges 2 are being interacted with. For example, in the one or more embodiments illustrated in FIG. 2, the control module 20 has communicated with the dial gauge interacting device 16 and verified that four dial gauges are being interacted with. In one or more embodiments, the control module 20 may be further configured to assign a center point of each of the middle dial gauges 2 by transposing a line from the center point of each of the end dial gauges 2.

In one or more embodiments, the control module 20 is configured for testing the utility meter 1 by imparting a flow of fluid of a predetermined volume therethrough and determining a value based on a plurality of the dial gauges 2 before and after the step of imparting a flow of fluid of a predetermined volume. In this manner, the control module 20 can impart a predetermined amount of fluid flow through the meter 1 and the compare the measured readings before and after the step of imparting fluid flow to determine whether the dial gauges 2 of the utility meter 1 are functioning properly.

In one or more embodiments, the control module 20 is configured for displaying on a display screen 22 a representative image 26 of the dial. An illustrative example of this is shown in FIG. 2 in which a representative image 26 is shown on display screen 22.

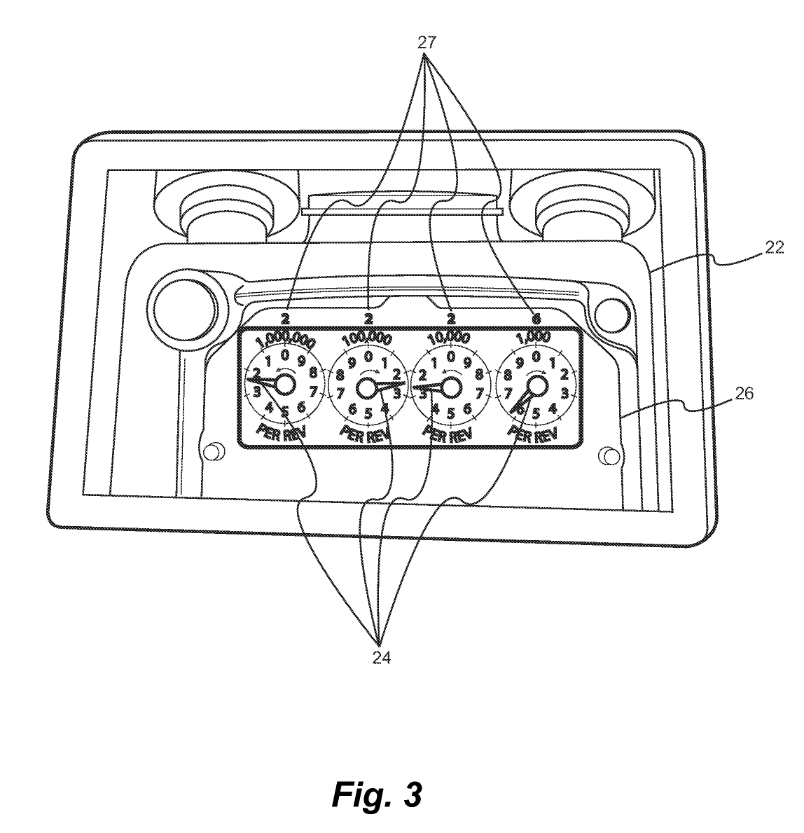

In one or more embodiments, the control module 20 is configured for determining an associated value of the at least one position of a dial of the at least one dial gauge. The associated value may be a representative image 26 as illustrated in FIG. 3, or a vector approximating the position of the dial gauge. The representative image 26 may include an associated value 27 that is indicative of the position of the dial pin 3, with the associated value 27 being displayed on the display screen 22.

The control module 20 may determine an associated value by assigning a representative vector 24 of each dial 2. This representation may be accomplished by comparing pixels as viewed by the dial gauge interacting device 16. For example, the dial gauge interacting device 16 may be configured to search for a string of pixels of a certain color, length, and the like that is indicative of a dial pin 3. The control module 20 may then determine an angle of the representative vector 24. The angle is the compared to a predetermined angle range. The control module can then determine a value 26 associated with the predetermined range. For example, in the dial gauges illustrated in FIGS. 2 and 3, each dial gauge 2 is represented by numbers 0 through 9. Accordingly, it is known that there are 36 degrees between each successive number as represented by the dial gauge 2 since there are 10 known numbers and 360 degrees about the dial face. Accordingly, it is known that the position of each number of the each dial gauge 2 can be represented by successive 36 degree increments. For example, if the measured angle is 35 degrees, it is determined that the dial pin is pointing between numbers 0 and 1, and therefore a value of 0 should be read. If the measured angle is 50 degrees, it is determined that the dial pin is pointing between numbers 1 and 2, and therefore a value of 1 should be read. If the measured angle is 350 degrees, it is determined that the dial pin is pointing between numbers 9 and 0, and therefore a value of 9 should be read.

In one or more embodiments, the gauge interacting device 16 may be configured for reading a stand-alone gauge or plurality of gauges, or, more specifically, a gauge that is not physically connected to a utility meter. The gauge interacting device 16 is configured for reading the one or more gauges 2 during a real-time measurement.

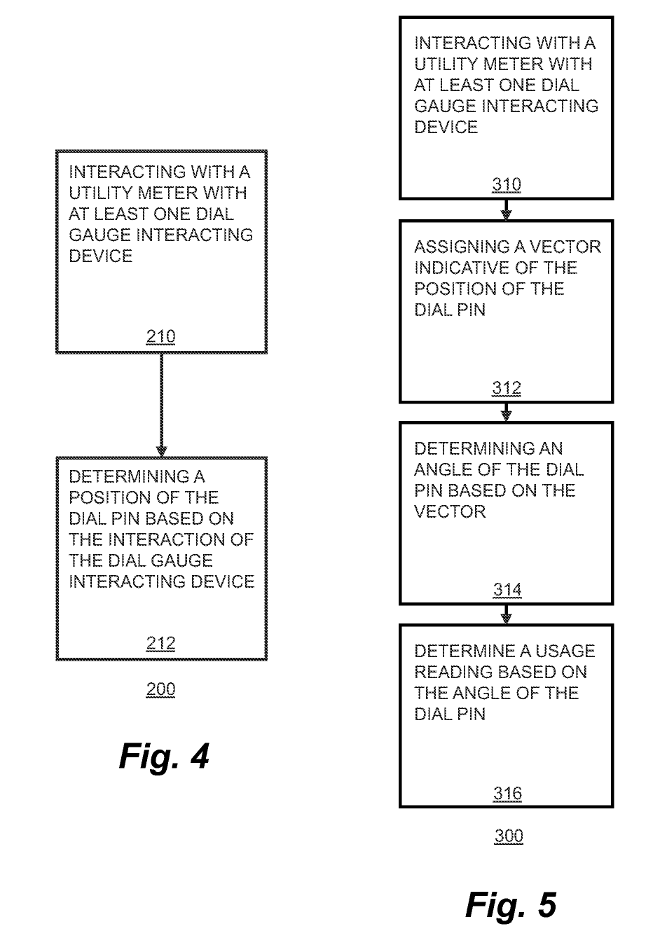

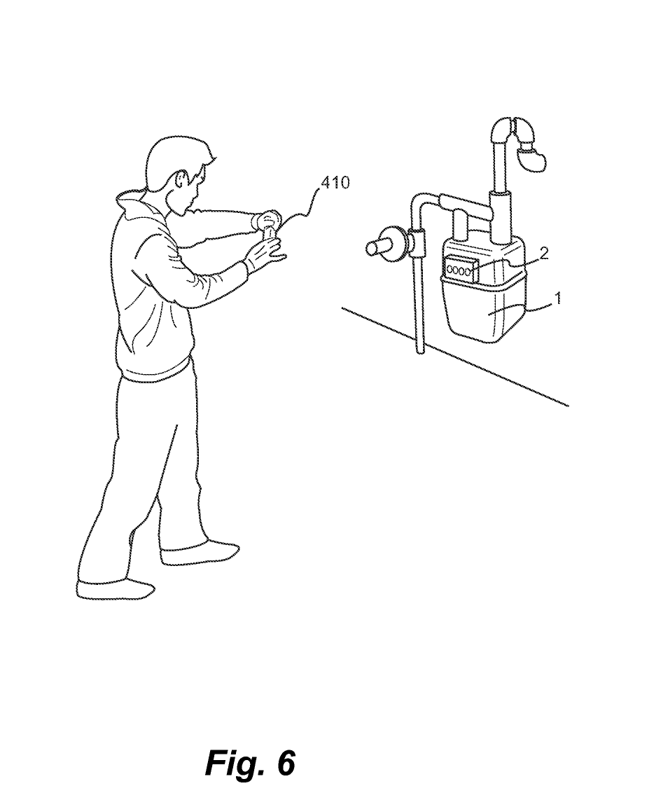

In one or more embodiments, the gauge interacting device 16 and control module 20 may be configured for comparing an image of the one or more dial gauges 2 with an image database to determine one or more values associated therewith. In this regard, the determination may not be “real-time” and may be made in a multiple-step process. In this manner, a flowchart is illustrated in FIG. 4 that details a method 200 for measuring a utility meter of the type having one or more dial gauges. The method 200 may include interacting with a utility meter with at least one dial gauge interacting device 210, such as, for example, dial gauge interacting device 16. The method 200 may further include determining a position of the dial pin based on the interaction of the dial gauge interacting device with the utility meter 212.

A flowchart is illustrated in FIG. 5 that details one or more methods in further detail to the one or more methods of FIG. 4. The one or more methods 300 include interacting with a utility meter with at least one dial gauge interacting device 210. The method 300 may further include assigning a vector indicative of the position of the dial pin by, for example, the dial gauge interacting device 16 and control module 20. Assigning a vector may be accomplished by any of a number of imaging techniques.

The method according to claim 12, further comprising assigning a vector indicative of the position of the dial pin of the dial gauge and determining an angle of the dial pin based on the vector. The method 300 may further include assigning a range of angles indicative of a position of the dial pin and comparing the angle of the vector to the range of angles to determine a position of the dial pin 314. In embodiments in which the utility meter includes a plurality of dials, the method 300 may further include interacting with each of the dials. The method may include determining a usage reading of the utility meter based on the interaction with each of the plurality of dials 316. The method 300 may further include, in instances in which there are a plurality of dial gauges, determining if a predetermined number of dial gauges are being interacted with. The method 300 may further include imparting a fluid flow through one of an input or output flow monitoring devices and comparing flow rates to the determined values of the utility meter. In this manner, the utility meter can be tested and calibrated for proper functioning. The method 300 may further include displaying a representative image of the vector on the display. The method 300 may further include displaying the usage reading on the display.

In one or more embodiments, the control module 20 may be further configured for assigning and storing information about the utility meter 1 in a computer memory. For example, in one or more embodiments, the control module 20 may be configured to store a serial number of the utility meter 1, previously determined dial gauge information, service dates, and the like.

Additionally, in one or more embodiments, the dial gauge interacting device 16 may be appropriately configured for use on a personal digital assistant or appropriately configured smart phone as a computing device. In this manner, the apparatus 10 can be portable and configured for in-the-field use. As referred to herein, the term “computing device” should be broadly construed. It can include any type of mobile device, for example, a smart phone, a cell phone, a pager, a personal digital assistant (PDA, e.g., with GPRS NIC), a mobile computer with a smart phone client, a portable media player device, a mobile gaming device, a tablet computer, a handheld computer, a laptop computer, set-top box, Internet radio, A/V network receiver, or the like. A computing device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE® smart phone, an iPAD® device, Samsung Rogue smart phone, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes and/or small screen sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

The computing device or control module may include an interface, which may be, in some embodiments, the display 22, while in other embodiments, may be any display whether formed with the dial gauge interacting device 16 or separate from. As referred to herein, an “interface” is generally a system by which users interact with a computing device. An interface can include an input for allowing users to manipulate a computing device, and can include an output for allowing the system to present information and/or data, indicate the effects of the user's manipulation, etc. An example of an interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the present disclosure may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the present disclosure may be implemented in other and next-generation mobile networks and devices as well. The mobile device is the physical equipment used by the end user, typically a subscriber to the wireless network. Typically, a mobile device is a 2.5G-compliant device or 3G-compliant device (or 4G-compliant device) that includes a subscriber identity module (SIM), which is a smart card that carries subscriber-specific information, mobile equipment (e.g., radio and associated signal processing devices), a user interface (or a man-machine interface (MMI), and one or more interfaces to external devices (e.g., computers, PDAs, and the like). The mobile device may also include a memory or data store.

Various techniques described herein may be implemented with hardware or software or, where appropriate, with a combination of both. Thus, the methods and apparatus of the disclosed embodiments, or certain aspects or portions thereof, may take the form of program code (i.e., executable instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. An apparatus for reading a utility meter of the type having a dial gauge with a dial pin, the apparatus comprising:
a dial gauge interacting device configured for interacting with the utility meter; and
a control module in communication with the dial gauge interacting device, the control module configured to determine a position of the dial based on the interaction of the dial gauge interacting device with the utility meter.

2. The apparatus according to claim 1, wherein the control module is configured to assign a vector indicative of the position of the dial pin of the dial gauge and determine an angle of the dial pin based on the vector.

3. The apparatus according to claim 2, wherein the control module is configured to assign a range of angles indicative of a position of the dial pin and compare the angle of the vector to the range of angles to determine a position of the dial pin.

4. The apparatus according to claim 3, wherein the dial gauge includes a plurality of dials and the dial gauge interacting device is configured to interact with each of the dials.

5. The apparatus according to claim 4, wherein the control module is configured to determine a usage reading of the utility meter based on the interaction with each of the plurality of dials.

6. The apparatus according to claim 5, wherein the dial gauge interacting device is configured to determine if a predetermined number of dial gauges are being interacted with.

7. The apparatus according to claim 5, further including one of an input flow or an output flow monitoring device, and further configured to impart a fluid flow through one of the input or output flow monitoring devices and compare flow rates to the determined values of the utility meter.

8. The apparatus according to claim 5, further including a display configured for displaying an image read by the interacting device.

9. The apparatus according to claim 6, wherein the control module is configured to display a representative image of the vector on the display.

10. The apparatus according to claim 9, wherein the control module is configured to display the usage reading on the display.

11. The apparatus according to claim 1, wherein the dial gauge interacting device and the control module are communicatively coupled with a smart phone.

12. A method for reading a utility meter of the type having one or more dial gauges having a dial pin indicative of a reading of the dial gauge, the method comprising:
interacting with a utility meter with at least one dial gauge interacting device; and
determining a position of the dial pin based on the interaction of the dial gauge interacting device with the utility meter.

13. The method according to claim 12, further comprising assigning a vector indicative of the position of the dial pin of the dial gauge and determining an angle of the dial pin based on the vector.

14. The method according to claim 13, further comprising assigning a range of angles indicative of a position of the dial pin and comparing the angle of the vector to the range of angles to determine a position of the dial pin.

15. The method according to claim 14, wherein the dial gauge includes a plurality of dials, and
further comprising, using the dial gauge interacting device, interacting with each of the dials.

16. The method according to claim 15, further comprising determining a usage reading of the utility meter based on the interaction with each of the plurality of dials.

17. The method according to claim 16, further comprising determining if a predetermined number of dial gauges are being interacted with.

18. The method according to claim 16, further including one of an input flow or an output flow monitoring device, and
further including imparting a fluid flow through one of the input or output flow monitoring devices and comparing flow rates to the determined values of the utility meter.

19. The method according to claim 18, further including displaying a representative image of the vector on the display.

20. The method according to claim 19, further including displaying the usage reading on the display.
